(19) United States
(12) Patent Application Publication
(10) Pub. No.: US 2006/0245664 A1
(43) Pub. Date: Nov. 2, 2006

(54) Method for image enlargement

(75) Inventors: Yu-Min Chang, Taipei (TW); Hsiang-Chun Lin, Taipei (TW)

Correspondence Address: BIRCH STEWART KOLASCH & BIRCH, PO BOX 747, FALLS CHURCH, VA, 22040-0747, US

(73) Assignee: Asmedia Technology Inc.

(21) Appl. No.: 11/411,895

(22) Filed: Apr. 27, 2006

(30) Foreign Application Priority Data
Apr. 28, 2005 (TW) 94113724

(51) Int. Cl. G06K 9/40

(52) U.S. Cl. 382/263

(57) ABSTRACT

The present invention describes a method for image enlargement with the following steps. An image is divided into several sampling regions. A reference value of each sampling regions is determined. Then, the reference value is compared with a threshold for having a result. Finally, according to the result, at least one inserted pixel value is computed.

### RELATED APPLICATIONS

The present application is based on, and claims priority from, Taiwan Application Serial Number 94113724, filed Apr. 28, 2005, the disclosure of which is hereby incorporated by reference herein in its entirety.

### FIELD OF THE INVENTION

The present invention relates to a method for image enlargement, and more particularly to a method for image enlargement in which the algorithm is chosen according to the properties of the image.

### BACKGROUND OF THE INVENTION

By the coming optical and digital time, the image data information plays an important key in daily life. Since the digital image has the characteristics of easy keep, transmittal, modification, and low cost, it is widely utilized in various fields. And the image processing technique becomes more and more important now.

The most-used image processing techniques are image enlargement and image compression. Image compression decreases the number of pixels in the image, and is achieved by conserving the important characteristics of the image. However, image enlargement increases the number of pixels in the image. That is, part of the image needs to be re-established. The deficient part needs to be filled up with the present information. Hence, how to obtain the best result in image enlargement has been an issue in recent years.

In conventional image enlargement techniques, a frame is processed by only one kind of algorithm. Since the content of the image may vary considerably, there maybe many kinds of image properties in a frame. Therefore, if same algorithm is used to enlarge the whole frame of the image, some part of the image may be poor in quality, while other parts of the image have good results in enlargement.

### SUMMARY OF THE INVENTION

Therefore, one objective of the present invention is to provide a method for image enlargement, in which the most proper algorithm is found out according to the content of the image during enlargement to obtain the best image quality.

Another objective of the present invention is to provide a method for image enlargement in which at least two kinds of algorithms are used to compute the needed insertion pixel value.

Still another objective of the present invention is to provide a method for image enlargement in which different algorithms are used according to the different values of sampling regions to obtain the best image quality.

Still another objective of the present invention is to provide a method for image enlargement in which the threshold may be set by the designer or the user according to practical demand to change the visual effect of the image.

According to the aforementioned objectives, the present invention provides a method for image enlargement including the following steps. First, an image is divided into a plurality of sampling regions. Then, a reference value of each sampling regions is determined. Then, the reference value is compared with a threshold for having a result. Finally, according to the result, at least one inserted pixel value is computed.

According to the preferred embodiment of the present invention, the step of determining the reference value of each sampling regions comprises supplying a filter to mask each sampling regions and then computing a plurality of pixel values in each sampling regions to obtain the reference value of each sampling regions. The step of computing the pixel values in each sampling regions is to compute each pixel values in each sampling regions in proper sequence. The filter is a high pass filter. The step of computing the inserted pixel value comprises using a high-frequency algorithm when the reference value is greater than the threshold and using a low-frequency algorithm when the reference value is less than the threshold. The high-frequency algorithm may be Lanczos2 algorithm, Lanczos3 algorithm, or Mitchell algorithm. The low-frequency algorithm may be Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

According to another objective, the present invention provides a method for image enlargement comprising the following steps. First, an image is divided into a plurality of sampling regions. Then, a reference value of each sampling regions is determined. Then, the reference value is compared with a threshold for having a result. Then, according to the result, a high-frequency algorithm is used when the reference value is greater than the threshold, and a low-frequency algorithm is used when the reference value is less than the threshold to compute at least one inserted pixel value.

According to the preferred embodiment of the present invention, the step of determining the reference value of each sampling regions comprises supplying a filter to mask each sampling regions and then computing a plurality of pixel values in each sampling regions to obtain the reference value of each sampling regions. The step of computing the pixel values in each sampling regions is to compute each pixel values in each sampling regions in proper sequence. The filter is a high pass filter. The high-frequency algorithm may be Lanczos2 algorithm, Lanczos3 algorithm, or Mitchell algorithm. The low-frequency algorithm may be Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

According to the objectives, the present invention provides a method for image enlargement and it comprises the following steps. An image is divided into a plurality of sampling regions. A high-frequency component of each sampling regions is determined. Then, according to the high-frequency component, at least one first algorithm is performed and at least one second algorithm is performed.

According to the preferred embodiment of the present invention, the first algorithm may be Lanczos2 algorithm, Lanczos3 algorithm, or Mitchell algorithm. The second algorithm may be Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow chart according to the preferred embodiment of the present invention;

FIG. 2 illustrates the sampling regions according to the preferred embodiment of the present invention; and

FIG. 3 illustrates the high pass filter used in the preferred embodiment of the present invention.

### DETAILED DESCRIPTION OF THE PREFERRED EMBODIMENT

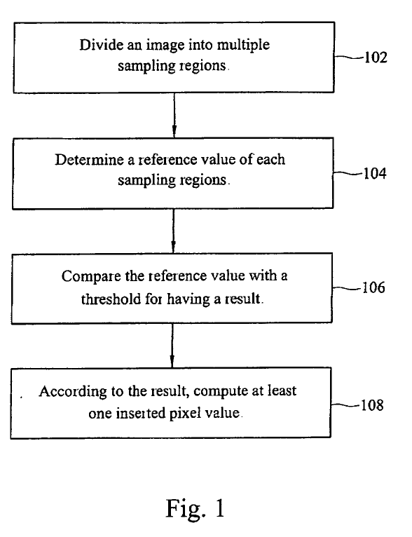

In order to make the illustration of the present invention more explicit and complete, the following description is stated with reference to FIG. 1 to FIG. 3.

FIG. 1 is a flow chart according to the preferred embodiment of the present invention. First, an image is divided into multiple sampling regions in step 102. The size of the sampling regions is n*n, where n is generally a positive integer. The size of the sampling regions is, of course, the bigger the better, so the more pixel values can be referenced. And, the inserted pixels, which are computed by the invention, are more correct. In the embodiment of the present invention, the size of the sampling regions is, for example, 4*4 or 6*6.

Then, a reference value of each sampling regions is determined in step 104. In the preferred embodiment of the present invention, the determining step is to supply a high pass filter to mask each sampling regions, and to compute multiple pixel values in each sampling regions masked by the high pass filter to obtain the reference value of each sampling regions. Then, the reference value is compared with a threshold for having a result in step 106. Then, according to the result, at least one inserted pixel value is computed, as shown in step 108. In the preferred embodiment of the present invention, according to the result, a high-frequency algorithm is used when the reference value is greater than the threshold, and a low-frequency algorithm is used when the reference value is less than the threshold to compute the inserted pixel value.

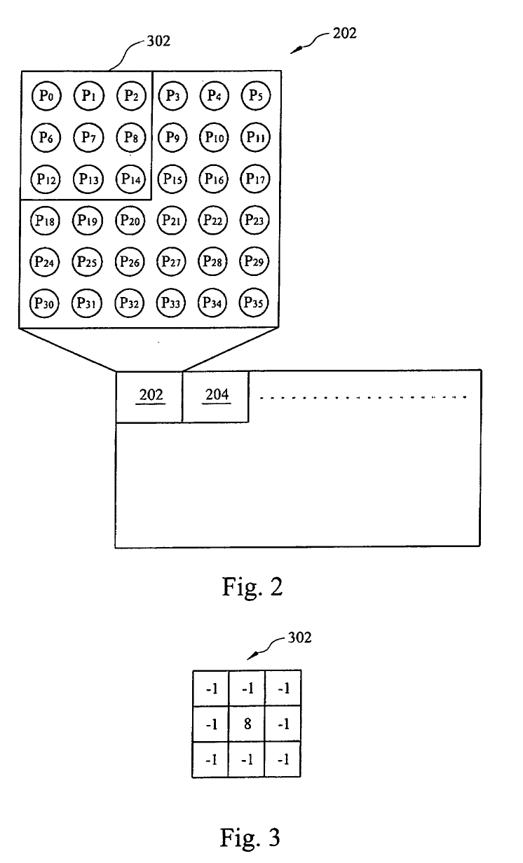

FIG. 2 illustrates the sampling regions according to the preferred embodiment of the present invention. In the preferred embodiment of the present invention, the sizes of the sampling regions are 6*6 for the sampling region 202 and the sampling region 204 shown in FIG. 2. Then, a mask is utilized to compute the pixel values in a sampling region. In the preferred embodiment of the present invention, a mask 302 is utilized to compute the pixel values in the sampling region 202. The mask 302 is a filter and there is no restriction on the size thereof. The only requirement is that the size of the mask 302 is less than the size of the sampling regions. The mask 302 in the preferred embodiment of the present invention is a high pass filter and the size is 3*3, as shown in FIG. 3. The high pass filter can emphasize the high frequency part of the image and strengthen the area with more variations of the image, i.e. strengthen the high frequency part. In FIG. 2, the mask 302 computes the inner product with the pixels P0, P1, P2, P6, P7, P8, P12, P13, and P14 in the sampling region 202, and obtains a first scalar value. It is noted that the high pass filter, the computing method of inner product, and the obtained scalar value are the examples of the invention. In other example of the invention, it may have different high pass filters or different computing method to have different result.

Then, the mask 302 is right-shifted to compute with the pixels P1, P2, P3, P7, P8, P9, P13, P14, and P15 to obtain a second scalar value. Then, the mask 302 is again right-shifted to compute with the pixels P2, P3, P4, P8, P9, P10, P14, P15, and P16 to obtain a third scalar value, and so on. In this way, after the mask 302 computes each pixel value in the sampling regions in proper sequence, i.e. in this way, after the mask 302 computes with the pixels P21, P22, P23, P27, P28, P29, P33, P34, and P35 in the sampling region 202, sixteen scalar values are obtained. The scalar values represent the high frequency components of the sampling region 202. The greater the value, the more severely the variation of the color in the sampling region 202.

Then, the moduli of the sixteen scalar values are added together to obtain a reference value. Then, the reference value is compared with a threshold for having a result. Then, according to the result, the inserted pixel value is computed. A reference value greater than the threshold indicates the existence of many high frequency parts in the sampling region 202. A high-frequency algorithm is then preferably used in the sampling region 202 to compute the inserted pixel value in the sampling region 202, such as inserting a pixel among the pixels P14, P15, P20, and P21. A reference value less than the threshold indicates the existence of many low frequency parts in the sampling region 202. A low-frequency algorithm is then preferably used in the sampling region 202 to compute the inserted pixel value in the sampling region 202, such as inserting a pixel among the pixels P14, P15, P20, and P21. For example, if the image to be enlarged is a face, then the sampling regions in the size of 4*4 or 6*6 are used to distinguish the details of the image, such as determining the distinct parts in the eyes and the smooth parts in the skin. Then, different inserting algorithms are used to obtain the inserted pixel values, respectively, such as using a high-frequency algorithm in the eye parts, and using a low-frequency algorithm in the skin parts.

Hence, a feature of the present invention is that in the method for image enlargement in the preferred embodiment of the present invention, at least two kinds of algorithms are used to compute the needed insertion pixel value.

Another feature of the present invention is that in the method for image enlargement in the preferred embodiment of the present invention, the most proper algorithm can be found out according to the content of the image during image enlargement to obtain the best image quality.

It is noted that the threshold may be set by the designer or the user according to practical need. For example, the threshold is set to be 300 in the preferred embodiment of the present invention. A greater threshold indicates the existence of fewer high frequency parts and more low frequency parts in the image. Therefore, the image will be smoother. Contrarily, a smaller threshold indicates the existence of fewer low frequency parts and more high frequency parts in the image. Therefore, the image will be sharper.

In the preferred embodiment of the present invention, the low-frequency algorithm is, for example, Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm. The high-frequency algorithm is, for example, Lanczos2 algorithm, Lanczos3 algorithm, or Mitchell algorithm. It is noted that the present invention is not limited to these algorithms.

According to the aforementioned description, the present invention has various advantages. For example, in the method for image enlargement of the present invention, the proper algorithms are chosen according to proper sampling regions. Further, different algorithms may be used according to different image properties. Additionally, the threshold may be set by the designer or the user according to practical need.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for image enlargement, comprising:
dividing an image into a plurality of sampling regions;
determining a reference value of each sampling regions;
comparing the reference value with a threshold for having a result; and
according to the result, computing at least one inserted pixel value.

2. The method for image enlargement according to claim 1, wherein the step of determining the reference value of each sampling regions comprises:
supplying a filter to mask each sampling regions; and
computing a plurality of pixel values in each sampling regions masked by the filter to obtain the reference value of each sampling regions.

3. The method for image enlargement according to claim 2, wherein the step of computing the pixel values in each sampling regions masked by the filter comprises:
computing each pixel values in each sampling regions in proper sequence.

4. The method for image enlargement according to claim 2, wherein the filter is a high pass filter.

5. The method for image enlargement according to claim 1, wherein the step of computing the inserted pixel value comprises:
using a high-frequency algorithm when the reference value is greater than the threshold.

6. The method for image enlargement according to claim 5, wherein the high-frequency algorithm is Lanczos2 algorithm, Lanczos3 algorithm, or Mitchell algorithm.

7. The method for image enlargement according to claim 1, wherein the step of computing the inserted pixel value comprises:
using a low-frequency algorithm when the reference value is less than the threshold.

8. The method for image enlargement according to claim 7, wherein the low-frequency algorithm is Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm Gaussian algorithm, or Sinc algorithm.

9. A method for image enlargement, comprising:
dividing an image into a plurality of sampling regions;
determining a reference value of each sampling regions;
comparing the reference value with a threshold for having a result; and
according to the result, using a high-frequency algorithm when the reference value is greater than the threshold and using a low-frequency algorithm when the reference value is less than the threshold to compute at least one inserted pixel value.

10. The method for image enlargement according to claim 9, wherein the step of determining the reference value of each sampling regions comprises:
supplying a filter to mask each sampling regions; and
computing a plurality of pixel values in each sampling regions masked by the filter to obtain the reference value of each sampling regions.

11. The method for image enlargement according to claim 10, wherein the step of computing the pixel values in each sampling regions masked by the filter comprises:
computing each pixel values in each sampling regions in proper sequence.

12. The method for image enlargement according to claim 10, wherein the filter is a high pass filter.

13. The method for image enlargement according to claim 9, wherein the high-frequency algorithm is Lanczos2 algorithm, Lanczos3 algorithm, or Mitchell algorithm.

14. The method for image enlargement according to claim 9, wherein the low-frequency algorithm is Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.

15. A method for image enlargement, comprising:
dividing an image into a plurality of sampling regions;
determining a high-frequency component of each sampling regions; and
according to the high-frequency component, performing at least one first algorithm and at least one second algorithm.

16. The method for image enlargement according to claim 15, wherein the first algorithm is Lanczos2 algorithm, Lanczos3 algorithm, or Mitchell algorithm.

17. The method for image enlargement according to claim 15, wherein the second algorithm is Cubic Convolution Interpolation algorithm, Nearest Neighborhood algorithm, Bilinear algorithm, Bicubic Convolution algorithm, Box algorithm, Triangle algorithm, Quadradic algorithm, Catrom algorithm, Gaussian algorithm, or Sinc algorithm.
